(19) United States
(12) Patent Application Publication
(10) Pub. No.: US 2007/0212505 A1
(43) Pub. Date: Sep. 13, 2007

(54) Method And Device For Punching A Part Of Moulded Fibre Material

(75) Inventors: Wijbe Dijstra, Dronrijp (NL); Wouter Josephus Kienstra, Wieuwerd (NL); Johannes Jelle Post, Sneek (NL); Harald John Kuiper, Heerenveen (NL)

Correspondence Address: THE WEBB LAW FIRM, P.C., 700 KOPPERS BUILDING, 436 SEVENTH AVENUE, PITTSBURGH, PA, 15219, US

(73) Assignee: HUHTAMAKI MOLDED FIBER TECHNOLOGY B,V,, FRANEKER (NL)

(21) Appl. No.: 10/579,378

(22) PCT Filed: Nov. 15, 2004
(86) PCT No.: PCT/NL04/00801

§ 371 Date: Feb. 21, 2007

(30) Foreign Application Priority Data
Nov. 13, 2003 (NL) 1024777

(51) Int. Cl. B28B 1/26; B29C 70/08

(52) U.S. Cl. 428/36.3; 264/153; 264/86

(57) ABSTRACT

A method and device are disclosed for punching products made of moulded fibre material. For this purpose there is a bearer on which a blank pre-moulded fibre material is placed from which the product or the products have to be punched. This bearer is made with a contour. The cutting die is provided with a corresponding contour, as a result of which during punching a cut line is produced that is not in one plane but is three-dimensional. Before the actual punching operation takes place, the peripheral edge of the larger blank is clamped close to the cutting location.

The present invention relates to a method for punching a part of material out of a larger part, comprising placing said larger part on a bearer and moving a cutting die from one side towards said larger part, wherein said larger part is clamped by said bearer on the side of said larger part.

Such a method is disclosed in U.S. Pat. No. 4,063,477 A. In this publication a method is described for making a cut-out in a mat. During cutting the larger part is clamped three-dimensionally and the part of the surface to be cut out is bearered. There is no bearer at the location of the cutting die. The cutting die comprises a narrow part that is so constructed that it comes into contact with the mat as little as possible. The method described in the US patent is intended in particular for cutting mats for cars.

Such a method functions satisfactorily for simple items, but, on the one hand, increasingly more stringent requirements are being imposed on the design of products and, on the other hand, new application possibilities for the environmentally friendly moulded fibre material are always being found. In this context it is, however, a condition that the product can be shaped in a certain way in these applications.

The aim of the present invention is to provide a method and device with which it is possible to produce more complicated products.

This aim is realized with a method as described above in that said part of material comprises moulded fibre material and said part to be punched out/punched out part is moved away from said larger part by said cutting die.

Here three-dimensional is understood to mean an item with an extension in the x, y and also the z direction, said extension being substantial in each direction.

It must be understood that moving “from one side” also includes variants where a movement is performed from both sides.

Here moulded fibre material is understood to be a material that has been prepared from an aqueous suspension of paper fibres, textile fibres and the like by putting said suspension onto/into a mould and removing the water therefrom, the moulded fibre material part persisting. This can then be subjected to a wide variety of types of treatments, such as re-pressing, colouring and the like. Such subsequent treatments can be carried out before or after the method described above.

By, in accordance with the present invention, transporting the punched-out part three-dimensionally along with the cutting die, it is possible to provide optimum bearer for complicated products.

The invention also relates to a method for punching a part of material out of a larger part, comprising placing said larger part on a bearer and moving a cutting die from one side towards said larger part, wherein said larger part is clamped by said bearer on the side of said larger part, wherein said punching comprises punching along a closed line that is not in one plane. This method can be used either in combination with the method described above or on its own.

The invention also relates to a method for punching a part of moulded fibre material out of a larger part, comprising placing said larger part on a bearer and moving a cutting die from one side towards said larger part, wherein said larger part is bearered by said bearer on the side of said larger part remote from the cutting die, wherein punching takes place three-dimensionally in more than one plane.

According to this aspect of the present invention it is possible, with or without the bearer described above, to produce products for which the boundary of the opening or the edge, obtained by punching, of the product obtained by punching is three-dimensional, that is to say is not in one plane. By this means a completely new design option for products made of moulded fibre material is produced. Moulded fibre material must be understood to be material produced from an aqueous pulp containing paper/wood/textile fibres and the like, which pulp is placed on a screen that has been provided with the desired shape. Subsequent treatment operations, such as drying and re-pressing can optionally take place.

It is possible to construct the bearer as a flat plate, which can be provided with the three-dimensional bearer described above. It is also possible to make the plate three-dimensional. According to an advantageous embodiment of the invention, the bearer involves clamping bearer. Clamping bearer is understood to mean that the item obtained from moulded fibre material is clamped on two sides. Preferably, this clamping takes place close to the location where punching or cutting is effected, so that fraying is avoided and the product is held in position in an optimum manner, as a result of which the punching line is accurately positioned relative to the product geometry.

Preferably, clamping takes place on that side of the item made of moulded fibre material which is subsequently thrown away. That is to say, in the case of an opening clamping will be on the part that is removed and when punching products out of a larger part the larger part will be bearered close to the peripheral edge.

It is possible to carry out the method in such a way that a relatively large number of different products or different openings are punched at the same time or shortly after one another. It is also possible, starting from different parts of moulded fibre material on a bearer, to produce products or openings simultaneously.

The invention also relates to a device for punching a part of moulded fibre material out of a larger part according to claim 13.

The invention also relates to a cutting die with a cutting edge that forms a closed line and is in more than one plane. Moreover, the cutting die is preferably provided with a bearer for transporting the product to be punched out. The cutting die can be used either in combination with the device described above or on its own with other devices according to the prior art.

The invention also relates to a product made of moulded fibre material and more particularly to a container-like part made of moulded fibre material. The terminating edge of this product is a punched edge and if a line is drawn along this punched edge this is a closed line that is in more than one plane.

The invention will be explained in more detail below with reference to an illustrative embodiment shown in the drawing. In the drawing:

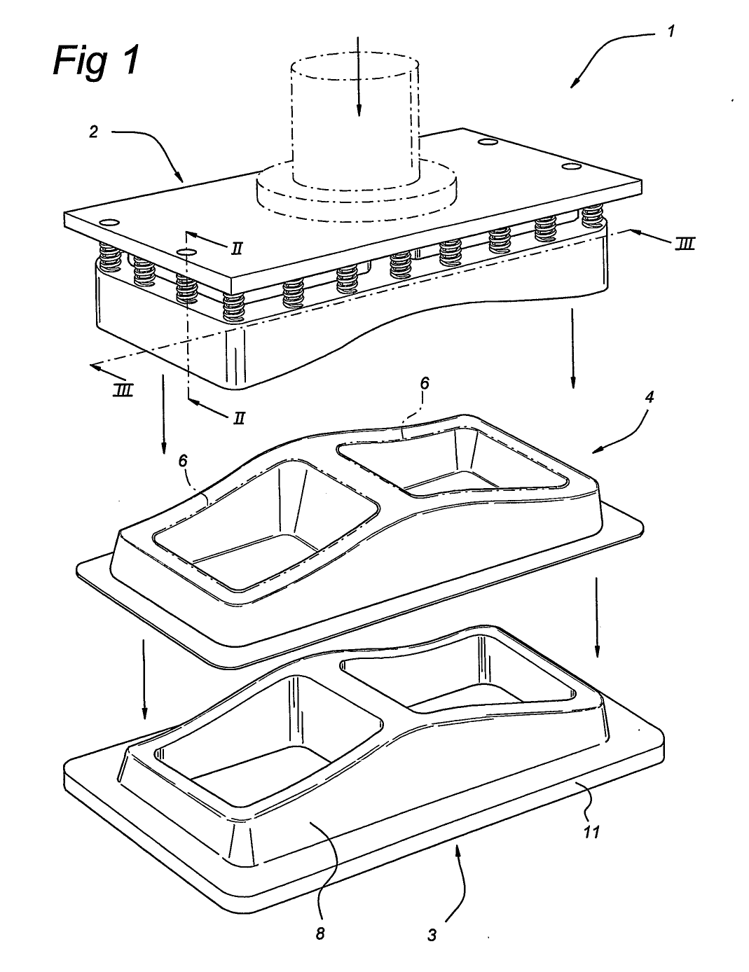

FIG. 1 shows, diagrammatically, a view of a punching die assembly according to the present invention;

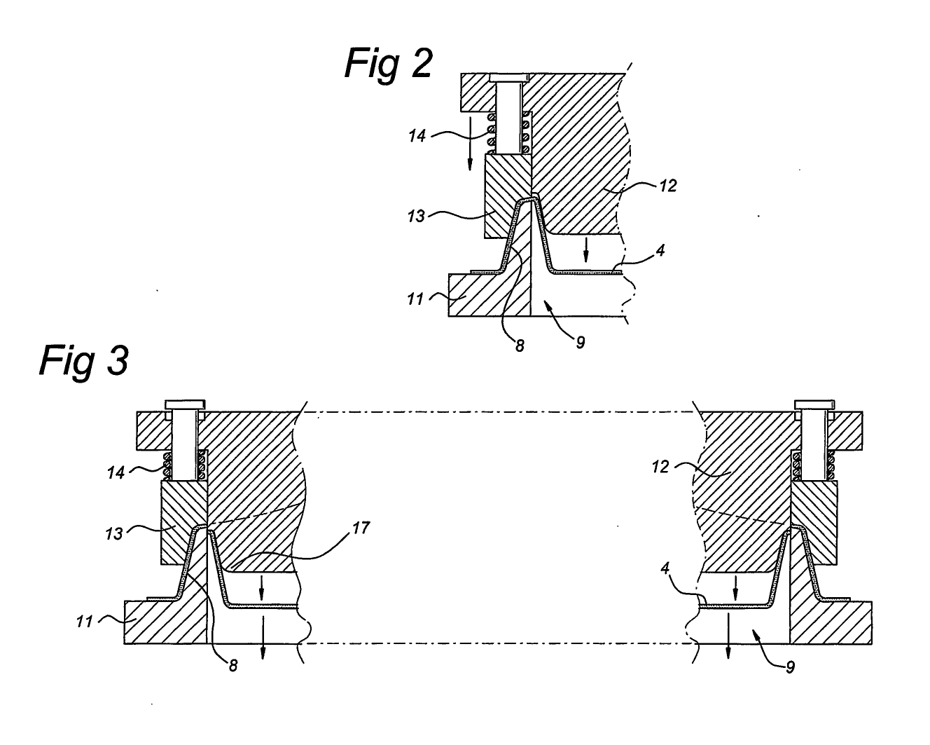

FIG. 2 shows a detail of the device according to FIG. 1 when partly closed in cross-section;

FIG. 3 shows the view according to FIG. 2 at the point in time when the cut is made; and

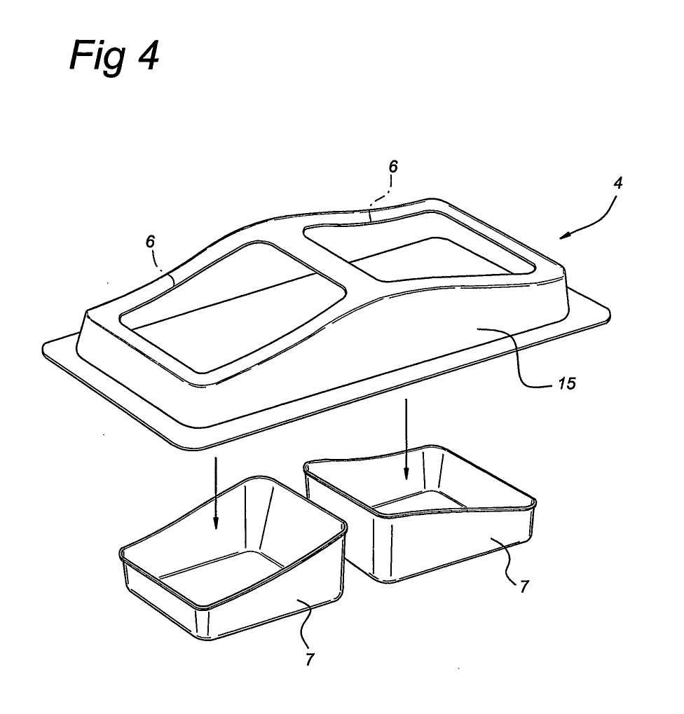

FIG. 4 shows two shaped items, as well as the remaining part.

In FIG. 1 the punching die assembly according to the invention is indicated in its entirety by 1. This consists of an upper die 2 and a lower die 3. Lower die 3 consists of an essentially flat bearer or plate 11 (see FIGS. 2 and 3) on which a raised edge 8 has been arranged. This can be a separate part or can be integral with the plate 11. A recess or (discharge) opening right through is delimited inside the raised edge. An opening delimited within this is indicated by 9 (see FIGS. 2 and 3).

As can be seen from FIGS. 2 and 3, upper die 2 is provided with a cutting die 12, as well as a clamping edge 13 bordering this. This is fixed with a spring 14 and associated guide such that it is able to slide relative to upper die 2.

It can be seen from FIG. 1 that there is a previously shaped product made of moulded fibre material. This three-dimensional part is indicated in its entirety by 4 and can be fitted precisely over the raised edge 8 of the bearer or plate 11. This is shown in FIG. 2. This, of course, is done in the position in which the upper die 2 is an appreciable distance away from the lower die 3. The upper die 2 is then lowered and during this operation clamping edge 13 will be the first to touch the larger part of moulded material 4. This is shown in FIG. 2. The upper die 2 can be lowered further because clamping edge 13 is resiliently joined thereto. During this operation spring 14 will be depressed. In this way it is also guaranteed that the material of the three-dimensional item that is clamped is not compressed too much but that it is secured precisely and well. The actual three-dimensional part will then separate into product and remainder. Such a separation takes place along a punching line 6 that is shown in FIG. 1. The cutting operation is shown in FIG. 3, whilst the products and the remaining part produced during this operation are shown in FIG. 4. In this figure the products are indicated by 7. 17 indicates the transport part of the cutting die by means of which the product to be punched out is moved out of the larger part during the punching operation.

According to the present invention either the bearer or the line of the cutting die 12 is three-dimensional. Optionally a combination can be used. By this means it is possible to punch the trays shown in FIG. 4. However, it is also possible to produce a wide variety of other types of items. It is not necessary that the cutting die delimits a closed line. For instance, it is possible to produce cut-outs and lips, respectively. Examples of such lips are spring lips that can be used in a wide variety of ways to clamp products or, alternatively, to hold them in place. It will be understood that instead of the products 7 it is possible for the remaining part 15 shown in FIG. 4 to be the desired product, or for both to be desired products. The surface area of the remaining part has been reduced as a result of punching. It will also be understood that more than one product can be punched out in one step and it is also possible to position more than one three-dimensional part on a plate 11 provided accordingly with various seats and to subject these to the punching operation simultaneously or immediately in succession. It will also be understood that after the punching operation a wide variety of finishing operations known in the state of the art can take place.

With the present invention it is possible, on the one hand, to produce products that have been completely cut free around the periphery thereof, so that it is no longer necessary to use bridges between the items, although this is possible in certain applications. On the other hand, it is possible to produce three-dimensional boundary edges by punching.

On reading the above variants will be immediately apparent to those skilled in the art that are obvious after the above and fall within the scope of the appended claims.

1-15. (canceled)

16. A method for punching a part out of a larger part, comprising placing said larger part on a bearer and moving a cutting die from one side towards said larger part, wherein said larger part is clamped by said bearer on the side of said larger part, said part of material comprising molded fibre material and after said part is punched out, said punched out part is moved away from said larger part by said cutting die.

17. The method according to claim 16, wherein the punched-out part is produced by said cutting die.

18. The method according to claim 16, wherein said bearer is three-dimensional.

19. The method according to claim 16, wherein said punching comprises punching along a closed line that is not in one plane.

20. The method according to claim 16, wherein said punching comprises making an opening/cut-out in a shaped fibre part.

21. The method according to claim 16, wherein said punching comprises punching a product made of moulded fibre material from a sheet.

22. The method according to claim 16, wherein said product is punched from a surrounding sheet of fibre material.

23. The method according to claim 22, wherein said surrounding sheet is produced.

24. The method according to claim 16, comprising placing said larger part on said bearer, followed by clamping the larger part to the bearer with the further bearer and punching.

25. A method for the production of a product made of moulded fibre material, comprising providing an aqueous pulp containing fibre material, putting this on a screen, removing water, drying the pulp and subjecting the pulp to a punching operation, said punching operation comprising punching a part out of a larger part, placing said larger part on a bearer and moving a cutting die from one side towards said larger part, wherein said larger part is clamped by said bearer on the side of said larger part, said part of material comprising moulded fibre material and after said part is punched out, said punched-out part is moved away from said larger part by said cutting die, wherein said punched-out part is produced by said cutting die.

26. The method according to claim 25, wherein said punching operation comprises punching out various products from said moulded fibre material at essentially the same time.

27. A container-like product, having a terminating edge, which terminating edge comprises a punched edge, which termination describes an essentially closed line, which line extends through more than one plane, where said container-like part has been produced from moulded fibre material.

28. A device for punching a part of moulded fibre material from a part with a larger surface area, comprising a bearer for said larger part of fibre material and a cutting die that can be moved towards said bearer, wherein a further three-dimensional bearer for said larger part of moulded material is fitted to said bearer on the side of said cutting die, wherein said device is designed to accommodate said larger part clamped between said bearer and said further bearer, wherein said cutting die is provided with transport means for a part which is punched out.

29. The device according to claim 28, wherein said transport means are in more than one plane and are three-dimensional.

30. The device according to claim 26, wherein said further bearer comprises a clamping member.
